(19) United States
(12) Patent Application Publication
(10) Pub. No.: US 2025/0347323 A1
(43) Pub. Date: Nov. 13, 2025

(54) ROLLING BEARING WITH SEALS AND A SEGMENTED SPACER RING BETWEEN THE SEALS

(71) Applicant: AKTIEBOLAGET SKF, GOTEBORG (SE)

(72) Inventors: Christophe Serge Jean Yves HOUDAYER, Semblancay (FR); Yannick Sébastien SARTON, Luynes (FR)

(21) Appl. No.: 19/194,167

(22) Filed: Apr. 30, 2025

(30) Foreign Application Priority Data
May 7, 2024 (DE) 102024204231.5

(51) Int. Cl. F16C 33/78; F16C 19/08

(52) U.S. Cl. CPC F16C 33/7823; F16C 19/08

(57) ABSTRACT

A rolling bearing includes a first ring and a second ring capable of rotating concentrically relative to one another. The bearing further includes at least two seals and a spacer ring axially arranged between the two seals and including a flange that radially outwardly projects toward the second ring, and an annular axial collar. The spacer ring has at least three dissociable segments circumferentially adjacent forming the spacer ring.

### CROSS-REFERENCE

This application claims priority to German patent application no. 102024204231.5 filed on May 7, 2024, the contents of which are fully incorporated herein by reference.

### BACKGROUND OF THE INVENTION

The present invention relates to the field of rolling bearings, and more particularly to large-diameter rolling bearings including an inner ring and an outer ring arranged concentrically about an axis of rotation running in an axial direction.

Large-diameter rolling bearings are generally known and may be used, for example, in marine applications, such as for example, in a tidal or marine turbine power station, in a tunnel boring machine, in a mining extraction machine or in a wind turbine.

A large-diameter rolling bearing generally comprises two concentric inner and outer rings, and at least one row of rolling elements, such as rollers or balls, arranged between the rings. The bearing also comprises seals disposed between the inner and outer rings to define a closed space inside of which the rolling elements are arranged.

Large-diameter rolling bearings are generally used in aggressive or harsh environments, in particular in marine applications. As such, the seals prevent exterior elements, such as dust, abrasive particles, water and marine species, for example, plankton and algae, from getting inside the bearing and damaging the bearing components. Such exterior elements may also alter the seal itself, leading to a reduction in the service life of the seal.

Generally, a plurality of additional adjacent seals is provided on the bearing front side which is directly in contact with the aggressive or harsh environments, for example with saltwater. These additional seals are fixed to a sealing ring of one of the inner and outer rings and comprise a sealing lip in sliding contact with a running surface of a sealing ring of the other ring. Hence, several adjacent closed outer chambers are delimited or defined between the sealing lips of the adjacent seals.

The seals may be separated by an annular spacer ring, which may be difficult to position during the assembly of the bearing due to the size and inability to adjust the spacer ring.

### SUMMARY OF THE INVENTION

It is therefore desirable to provide a rolling bearing comprising effective sealing elements that prevent the entry of exterior elements, have an increased service life, particularly in aggressive environments, and are easy to implement.

One aim of the present invention is to solve the above difficulties.

The present invention relates to a rolling bearing comprising a first ring and a second ring capable of rotating concentrically relative to one another, and at least one row of rolling elements arranged between first and second raceways of the first and second rings, the first ring comprising at least one first rolling ring provided with the first raceway, and the second ring comprising at least one second rolling ring provided with the second raceway, the rolling bearing further comprising at least two seals each having an annular heel mounted on a cylindrical surface of the first ring, and at least one sealing lip in frictional contact with the second ring.

The rolling bearing also comprises a spacer ring mounted on the first ring and axially arranged between the annular heels of the two seals.

According to one aspect of the invention, the spacer ring comprises at least three dissociable or separable segments circumferentially adjacent and forming the spacer ring. In other words, the spacer ring is split into at least three successive ring segments. The spacer ring is formed as a slit ring in the circumferential direction.

Thus, the segmentation of the spacer ring into multiple segments facilitates the assembly and the disassembly of the spacer ring, and of the rolling bearing in general.

Advantageously, the spacer ring includes an annular groove facing the cylindrical surface of the first ring.

Preferably, the spacer ring abuts radially against the cylindrical surface of the first ring, in the same manner as the annular heel of each seal abuts radially again the cylindrical surface.

Advantageously, the spacer ring includes a flange that radially outwardly projects toward the second ring, the flange extending obliquely with a support surface inclined in the same direction as the sealing lip of one of the seals, and an annular axial collar that radially blocks the annular heel of the other seal in a radially outward direction.

Advantageously, each segment has the same size as the other segments.

Preferably, each segment includes at least one axial through hole opening on either side onto one of the seals.

Advantageously, each segment comprises only one axial through hole positioned in the middle of the circumferential length of the segments.

In another embodiment, each segment comprises at least two axial through holes, each axial through hole being positioned regularly or evenly along the circumferential length of each segment.

Preferably, the axial through hole comprises a tapping or thread.

In one embodiment, the rolling bearing comprises at least three seals and two spacer rings spaced apart from each other by one of the seals, which is interposed axially.

Preferably, the segments are manufactured by 3D printing, and/or by stamping, and/or by turning, and/or by grinding.

In one embodiment, the first ring is the inner ring and the second ring is the outer ring. Alternatively, the first ring is the outer ring and the second ring is the inner ring.

### BRIEF DESCRIPTION OF THE SEVERAL VIEWS OF THE DRAWINGS

The present invention and its advantages will be better understood by studying the detailed description of specific embodiments given by way of non-limiting examples and illustrated by the appended drawings on which:

FIG. 1 is a cross-section of a rolling bearing according to the invention;

FIG. 2 is a partial cross-section of the rolling bearing of FIG. 1 according to other cutting planes; and

FIG. 3 is a schematic view of a segmented spacer ring of the rolling bearing of FIG. 1.

### DETAILED DESCRIPTION OF THE INVENTION

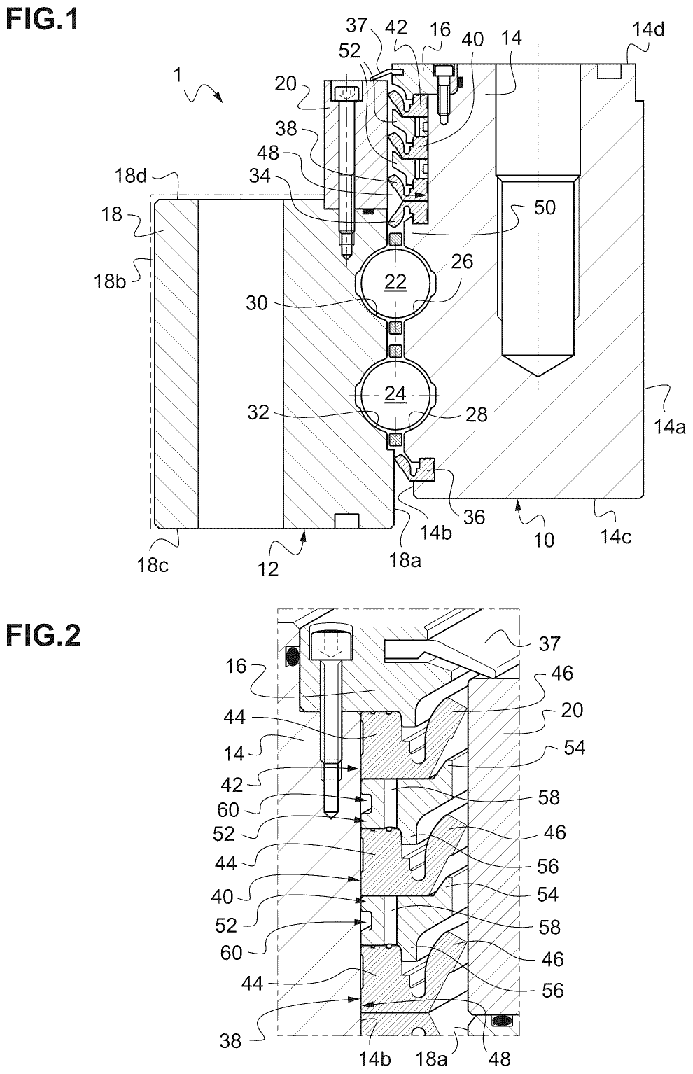

The rolling bearing 1 as illustrated in FIG. 1 is a large-diameter rolling bearing comprising a first ring 10 and a second ring 12. In the illustrated example, the first ring 10 is an outer ring whereas the second ring 12 is an inner ring. The rolling bearing 1 may be, for example, used in a tidal or marine turbine power station a tunnel boring machine, a wind turbine, a big offshore crane or any other applications using a large diameter rolling bearing.

The outer and inner rings 10, 12 are concentric and extend axially along the bearing rotation axis (not shown) which runs in an axial direction. In this illustrated example, the rings 10, 12 are of the solid type.

The outer ring 10 includes a first rolling ring 14 and a sealing ring 16 secured to the first rolling ring 14. The inner ring 12 also includes a second rolling ring 18 and a scaling ring 20 secured to the second rolling ring 18. Alternatively, the rolling ring 18 and the sealing ring 20 may be made in one part; i.e., integrally formed as one piece. The sealing ring 16 of the outer ring 10 partially and radially surrounds the sealing ring 20 of the inner ring 12.

In the illustrated example, the rolling bearing also comprises two rows of balls 22, 24 which are arranged between first raceways 26, 28 of the first rolling ring 14 of the outer ring 10 and second raceways 30, 32 of the second rolling ring 18 of the inner ring 12.

The second rolling ring 18 of the inner ring 12 includes an outer cylindrical surface 18a on which the raceways 30, 32 are formed. The raceways 30, 32 are oriented radially outward. The second rolling ring 18 also comprises an inner cylindrical surface or bore 18b which is radially opposite to the outer surface 18a. The second rolling ring 18 further includes two opposite, first and second frontal surfaces 18c, 18d which axially delimit the outer surface 18a and the bore 18b. The frontal surfaces 18c, 18d delimit the axial thickness of the second rolling ring 18.

The first rolling ring 14 of the outer ring 10 includes an outer cylindrical surface 14a and a cylindrical surface 14b which is radially opposite to the outer surface 14a and on which the raceways 26, 28 are formed. The raceways 26, 28 are oriented radially inward. The first rolling ring 14 further includes two opposite, first and second frontal surfaces 14c, 14d which axially delimit the outer surface 14a and the cylindrical surface 14b. The frontal surfaces 14c, 14d delimit the axial thickness of the first rolling ring 14.

The rolling bearing further includes, axially on each side of the rolling rings 14 and 18, an annular seal 34, 36 mounted on the first rolling ring 14 and provided to close/enclose the radial space (not indicated) that exists between the rolling rings 14, 18. The radial space is defined between the surface 14b of the first rolling ring 14 and the outer surface 18a of the second rolling ring 18. An annular closed rolling space (not referenced) is defined between the rolling rings 14, 18 and the seals 34, 36 in which the rows of balls 22, 24 are housed. Advantageously, the rolling space is filled with lubricant.

Each seal 34, 36 is mounted within a groove (not referenced) formed on the cylindrical surface 14b of the first rolling ring 14 and contacts the second rolling ring 18. Specifically, the seal 34 contacts the outer surface 18a of the second rolling ring 18 and the seal 36 contacts the outer surface 18a of the second rolling ring 18. Alternatively, it is possible to provide a reversed arrangement for at least one of the two seals 34, 36 with the seal 34 or 36 mounted on the second rolling ring 18 and coming into frictional contact with the first rolling ring 14.

The sealing ring 16 of the outer ring 10 is mounted axially into contact against the frontal surface 14d of the first rolling ring 14. The sealing ring 16 protrudes axially with regard to the first rolling ring 14. The sealing ring 16 is reversely attached or secured to the first rolling ring 14. The sealing ring 16 partially and radially surrounds the sealing ring 20 of the inner ring 12. Each of the sealing rings 16, 20 may be made of stainless steel or treated steel with a painting or anti-corrosion treatment.

The sealing ring 16 also includes a seal lip 37 extending from the sealing ring 16 toward the sealing ring 20 in order to prevent sand or particles from entering between the first ring 10 and the second ring 12.

As more precisely illustrated on FIG. 2, a plurality of successive annular seals are radially provided between the first rolling ring 14 of the outer ring and the sealing ring 20 of the inner ring.

In the illustrated example, the rolling bearing 1 is provided with first, second, and third successive seals 38, 40 and 42 supported by the first rolling ring 14 of the outer ring 10. The seals 38, 40 and 42 are arranged successively in the axial direction; in other words, the seals 38, 40 and 42 are spaced axially apart.

The seals 38, 40 and 42, as well as the annular seals 34 and 36, may be made of elastomeric material, such as for example, polyurethane, but may be made of any other appropriate material.

The seals 38, 40, 42 are intended to limit or prevent the infiltration of liquids, particles and dust from the subsea environment between the inner ring 12 and the outer ring 10.

The first, second, and third successive seals 38, 40 and 42 are disposed axially outwardly with respect to the annular seal 34.

Each seal 38, 40, 42 is provided with an annular heel 44 and with a sealing lip 46 projecting from the heel 44. In the illustrated example, each sealing lip 46 extends inwardly and obliquely from the annular heel 44. Each sealing lip 46 extends obliquely outward.

The sealing lips 46 are flexible in the radial direction. Each sealing lip 46 is elastically deformed and in sliding frictional contact with a sliding contact surface of the second ring 12, preferably a surface of the second sealing ring 20, for example at the same level as the outer surface 18a.

The cylindrical surface 14b is more precisely provided with an annular groove 48 open radially toward the inner ring 12. The annular groove 48 is bounded axially between a shoulder 50 of the first rolling ring 14 and the first sealing ring 16. The shoulder 50 is formed by removing material on the cylindrical surface 14b so as to thereby also form the groove 48.

The seals 34, 38, 40 and 42 are mounted on the cylindrical surface 14b, more precisely within the annular groove 48.

The rolling bearing 1 also comprises first and second spacer rings 52 arranged in the annular groove 48. The two spacer rings 52 are each annular and has two opposing axial sides (not indicated). The first spacer ring 52 is mounted axially between the annular heel 44 of the seal 38 and the annular heel 44 of the seal 40. The second spacer ring 52 is mounted axially between the annular heel 44 of the seal 40 and the annular heel of the seal 42.

In the depicted embodiment, the two spacer rings 52 are similar or similarly formed.

Each spacer ring 52 includes a flange 54 that projects radially outwardly toward the second ring 12. Each flange 54 extends obliquely and is provided with a support surface inclined in the same direction as the sealing lip 46 of the one seal 40, 42, for example the second seal 40, in order to prevent any reversion or inversion of the sealing lip 46.

Each spacer ring 52 further includes an annular axial collar 56 configured to radially block the annular heel 44 of another one of the seals 38, 40 on the axial side of the ring 52 opposed to the seal 40, 42 toward which the flange 54 extends, so that the seal 38 or 40 is prevented from displacing in a radial outward direction.

The annular heels 44 of the axially adjacent seals 38, 40 and 42 are axially maintained between the seal 34, the first sealing ring 16 and the different spacer rings 52, the seal 34 being maintained by the shoulder 50.

Furthermore, the annular heel 44 of each one of the seals 38, 40 and 42 is radially maintained between the annular axial collar 56 of one spacer ring 52 and the cylindrical surface 14b, more precisely the section of the cylindrical surface 14b inside the annular groove 48.

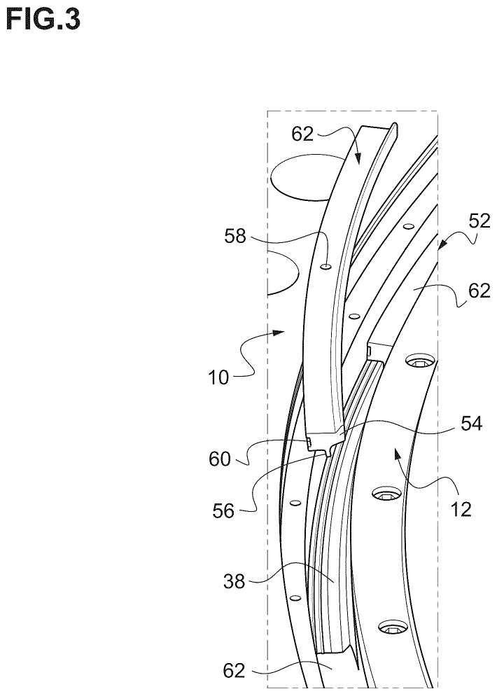

As shown partly on FIG. 3, each spacer ring 52 is divided in the circumferential direction, such that the spacer ring 52 is segmented. Preferably, the spacer ring 52 includes at least three dissociable or separable successive circumferential segments 62 circumferentially adjacent to each other so as to form the spacer ring 52. A spacer ring 52 can comprise between three (3) and fifty (50) separate segments 62, preferably between three (3) and twenty-five (25) segments 62.

Each separate segment 62 is provided with a first circumferential end and a second circumferential end which delimit the segment 62 in the circumferential direction. The first circumferential end of each one of the segments 62 abuts in the circumferential direction against the second circumferential end of one successive segment 62, and the second circumferential end of each one of the segments 62 abuts in the circumferential direction against the first circumferential end of one other successive segment 62.

In one embodiment, the segments 62 may be identical one to another; i.e., identically formed. During assembly of the bearing 1, each segment 62 is positioned against a seal 38, 40 or 42 and all of the segments 62 together form the spacer ring 52. The last segment 62 to be positioned can be adjusted in terms of length and position to the free space that still available in order to create a keystone and provide the desired rigidity for the spacer ring 52.

These segments 62 are easy to install axially during assembly of the rolling bearing 1. The segments 62 are also easy to remove and be replaced by new elements during a maintenance operation.

Moreover, these segments 62 minimize the impact of a deformation of the spacer ring 52, in particular when the ring 52 has a relatively large diameter, for example, a diameter of more than one meter.

In this embodiment, each segment 62 may include an axial hole 58, the axial hole 58 preferably being positioned or located at about the middle of a circumferential length of the segment 62. The axial hole 58 is provided for handling purposes during assembly or disassembly of the rolling bearing 1.

In one embodiment, each segment 62 may include two or more axial holes 62, each axial hole 58 being positioned regularly along the circumferential length of each segment 62 such that the two axial holes 58 are spaced apart evenly along the circumferential length of the segment 62.

Advantageously, each axial hole 62 includes a tapping or thread in order to facilitate the insertion of a screw or a bolt and to secure the spacer ring 52 to a lifting machine.

Advantageously, each axial hole 62 is a through-hole opening on each one of the two opposing axial sides of the spacer ring 52.

Each spacer ring 52 also includes an annular groove 60 facing the cylindrical surface 14b of the first ring 10. The annular groove 60 is designed to be in fluid communication with radial channels (not shown) through the spacer ring 52 for sealing testing, for example air-leakage test, or for lubrication purposes.

Alternatively, the rolling bearing I may include a different number of seals and/or of spacer rings 52.

Otherwise, as previously mentioned, in the illustrated examples, the first ring 10 of the rolling bearing is the outer ring whereas the second ring 12 is the inner ring. As an alternative, it could be possible to provide a reversed arrangement with the first ring 10 forming the inner ring and the second ring 12 forming the outer ring.

In the described examples, the rolling bearing 1 comprises two rows of rolling elements 22, 24. Alternatively, the rolling bearing I may comprise only a single or “one” row of rolling elements, or three or more rows of rolling elements. In the illustrated example, the rolling elements are balls, but the rolling bearing 1 may comprise any other types of rolling elements, for example cylindrical rollers, or any combination of any other appropriate rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A rolling bearing comprising:
a first ring including at least one first rolling ring provided with a first raceway;
a second ring including at least one second rolling ring provided with a second raceway, the first and second rings being capable of rotating concentrically relative to one another;
at least one row of rolling elements arranged between the first and second raceways of the first and second rings;
at least two seals, each seal having an annular heel mounted on a cylindrical surface of the first ring and a sealing lip in frictional contact with the second ring; and
at least one spacer ring mounted on the first ring and axially arranged between the annular heels of the at least two seals, the at least one spacer ring including at least three separate segments circumferentially adjacent and forming the spacer ring.

2. The rolling bearing according to claim 1, wherein the at least one spacer ring includes an annular groove facing the cylindrical surface of the first ring.

3. The rolling bearing according to claim 1, wherein the at least one spacer ring includes a flange projecting radially outwardly toward the second ring, the flange extending obliquely with a support surface inclined in the same direction as the sealing lip of one of the at least two seals, and an annular axial collar configured to radially block an annular heel of the other one of the at least two seals so as to prevent the seal from displacing in a radially outward direction.

4. The rolling bearing according to claim 1, wherein each segment of the at least one spacer ring is sized the same as each other segment of the at least one spacer ring.

5. The rolling bearing according to claim 1, wherein each segment of the at least one spacer ring has two opposing axial sides and includes at least one axial through hole opening on each axial side onto a separate one of the at least two seals.

6. The rolling bearing according to claim 5, wherein each segment of the at least one spacer ring includes a single axial through hole positioned in the middle of a circumferential length of each segment.

7. The rolling bearing according to claim 5, wherein each segment of the at least one spacer ring includes at least two axial through holes, the two axial through holes being spaced apart evenly along a circumferential length of each segment.

8. The rolling bearing according to claim 5, wherein the at least one axial through hole includes a thread.

9. The rolling bearing according to claim 1, wherein the at least two seals includes at least three seals and the at least one spacer ring includes two spacer rings spaced apart from each other such that one of the at least three seals is interposed axially between the two spacer rings.

10. The rolling bearing according to claim 1, wherein the segments of the at least one spacer ring are manufactured by at least one of 3D printing, stamping, turning and grinding.
